(19) United States
(12) Patent Application Publication
(10) Pub. No.: US 2025/0341539 A1
(43) Pub. Date: Nov. 6, 2025

(54) Method for Measuring the Response of an Accelerometer at Accelerations Greater than 1 G

(71) Applicant: InvenSense, Inc., San Jose, CA (US)

(72) Inventors: Carlo Pinna, Milan (IT); Gianluca Radaelli, Lesmo (IT); Vito Avantaggiati, Milano (IT); Aurelio Pellegrini, Sestola (IT); Riccardo Russo, Milan (IT); Gabriele Pelli, Mortara (IT); Daniele Ghezzi, Cusano (IT); Edoardo Belloni, Milan (IT); Adolfo Giambastiani, Lucca (IT)

(21) Appl. No.: 19/199,013

(22) Filed: May 5, 2025

Related U.S. Application Data
(60) Provisional application No. 63/642,217, filed on May 3, 2024.

(51) Int. Cl. G01P 21/00; G01P 15/08

(52) U.S. Cl. CPC G01P 21/00; G01P 15/08; G01P 2015/0865

(57) ABSTRACT

A method for measuring the response of a MEMS accelerometer at accelerations greater than 1 G uses test electrodes to apply an acceleration to proof masses during a test procedure. The MEMS accelerometer is placed in one orientation where test electrodes apply an electromagnetic force to the proof mass, where sense electrodes then detect those movements. Afterwards, the test electrodes apply another electromagnetic force, but with the MEMS accelerometer in another orientation (e.g., opposite the first orientation). The sense signals may be converted into a transfer characteristic that may be compared to other MEMS accelerometers to determine particular characteristics of the MEMS accelerometer such as operability, best-use application, failure point, and sensitivity.

### CROSS-REFERENCE TO RELATED APPLICATIONS

This application claims priority to U.S. Provisional Patent Application No. 63/642,217, filed May 3, 2024, and entitled “Method of Sensitivity Measurement of an Accelerometer at Accelerations Greater than 1 G,” which is incorporated by reference herein in its entirety.

### Background

Numerous items such as smart phones, smart watches, tablets, automobiles, aerial drones, appliances, aircraft, exercise aids, and game controllers may utilize sensors such as microelectromechanical system (MEMS) sensors during their operation. In many applications, various types of motion sensors such as accelerometers and gyroscopes may be analyzed independently or together in order to determine varied information for particular applications. For example, gyroscopes and accelerometers may be used in gaming applications (e.g., smart phones or game controllers) to capture complex movements by a user, drones and other aircraft may determine orientation based on gyroscope measurements (e.g., roll, pitch, and yaw), and vehicles may utilize measurements for determining direction (e.g., for dead reckoning) and safety (e.g., recognizing skid or roll-over conditions).

In some applications, a MEMS device such as a MEMS accelerometer can experience a wide range of forces, both in terms of magnitude of acceleration and direction. Acceleration forces can reach levels many times greater than 1 G, and it may be necessary in certain applications to have accuracy and precision both at lower acceleration values and for higher accelerations. Measuring the functionality and performance of MEMS accelerometers at high accelerations has proven to be difficult and complex.

### SUMMARY

In some embodiments of the present disclosure, a method for testing a response of a MEMS accelerometer to accelerations greater than 1 G comprises placing the MEMS accelerometer at a first orientation relative to gravity, wherein in the first orientation a proof mass of the MEMS accelerometer is located above a sense electrode of the MEMS accelerometer and a test electrode of the MEMS accelerometer, and wherein the proof mass experiences a force of gravity at the first orientation. The method can further comprise applying a first voltage to the test electrode, wherein the first voltage causes a first movement of the proof mass and measuring, by the sense electrode, a first sense signal corresponding to the force of gravity and the first movement of the proof mass. The method can further comprise placing the MEMS accelerometer at a second orientation relative to gravity that is opposite the first orientation, wherein in the second orientation the proof mass is located below the sense electrode and the test electrode, and wherein the proof mass experiences an equal and opposite force to the force of gravity at the second orientation of the MEMS accelerometer. The method can further comprise applying, to the test electrode, a second voltage to the test electrode, wherein the second voltage causes a second movement of the proof mass and measuring, by the sense electrode, a second sense signal corresponding to the equal and opposite force and the second movement of the proof mass. The method can further comprise determining, based on the first voltage, the second voltage, the first sense signal, and the second sense signal, a sensitivity of the MEMS accelerometer to a first acceleration value greater than 1 G.

In some embodiments of the present disclosure, a system for testing a response of a (MEMS accelerometer to accelerations greater than 1 G comprises a proof mass, a sense electrode, a test electrode, a power source, and processing circuitry. The processing circuitry can be configured to apply, while the MEMS accelerometer at a first orientation relative to gravity, a first voltage from the power source to the test electrode, wherein the first voltage causes a first movement of the proof mass, wherein in the first orientation the proof mass is located above the sense electrode and the test electrode, and wherein the proof mass experiences a force of gravity at the first orientation. The processing circuitry can further be configured to receive, from the sense electrode, a first sense signal corresponding to the force of gravity and the first movement of the proof mass and apply, while the MEMS accelerometer at a second orientation relative to gravity that is opposite the first orientation, a second voltage to the test electrode, wherein the second voltage causes a second movement of the proof mass, wherein in the second orientation the proof mass is located below the sense electrode and the test electrode, and wherein the proof mass experiences an equal and opposite force to the force of gravity at the second orientation of the MEMS accelerometer. The processing circuitry can further be configured to receive, from the sense electrode, a second sense signal corresponding to the equal and opposite force and the second movement of the proof mass and determine, based on the first voltage, the second voltage, the first sense signal, and the second sense signal, a sensitivity of the MEMS accelerometer to a first acceleration value greater than 1 G.

### BRIEF DESCRIPTION OF DRAWINGS

The above and other features of the present disclosure, its nature, and various advantages will be more apparent upon consideration of the following detailed description, taken in conjunction with the accompanying drawings in which:

FIG. 1 shows an illustrative MEMS system in accordance with an embodiment of the present disclosure;

FIG. 2A depicts an exemplary MEMS accelerometer whereby its response is measured in a first orientation relative to gravity at accelerations>1 G during a physical acceleration on a test machine;

FIG. 2B depicts an exemplary MEMS accelerometer whereby its response is measured in a second orientation, that is opposite the first orientation, at accelerations>1 G during a physical acceleration on a test machine;

FIG. 3A depicts an exemplary MEMS accelerometer whereby its response is measured in a first orientation relative to gravity at accelerations>1 G during an electromagnetic acceleration test in accordance with an embodiment of the present disclosure;

FIG. 3B depicts an exemplary MEMS accelerometer whereby its response is measured in a second orientation, that is opposite the first orientation, at accelerations>1 G during an electromagnetic acceleration test in accordance with an embodiment of the present disclosure;

FIG. 3C depicts an exemplary MEMS accelerometer whereby its response is measured in a third orientation, that is a tilted version of the first orientation, at accelerations>1 G during an electromagnetic acceleration test in accordance with an embodiment of the present disclosure;

FIG. 4 depicts a plot of an accelerometer transfer function that conveys the relationship between the measured acceleration output and the actual acceleration in accordance with an embodiment of the present disclosure; and

FIG. 5 depicts exemplary steps of determining the response of a MEMS accelerometer at accelerations>1 G during an electromagnetic acceleration test in accordance with an embodiment of the present disclosure.

### DETAILED DESCRIPTION

There exists general methods of testing MEMS accelerometers for their functionality, efficacy, sensitivity, and other characteristics so that they may be implemented in a variety of applications. Many applications (e.g., automotives, aerospace, industrial machining, sports, trauma monitoring) where MEMS accelerometers are employed can routinely exert large acceleration forces onto the sensors. Under these conditions, the acceleration forces can reach levels much larger than 1 G. Testing methods at acceleration levels greater than 1 G generally require test machines and equipment that apply a physical acceleration force to the MEMS accelerometer. Equipment for such tests tends to be bulky and expensive, and difficult to maintain.

The present disclosure describes systems and methods to test the response of MEMS accelerometers at large acceleration levels (e.g., multiples or orders of magnitude greater than 1 G), without requiring external text equipment or other machines to apply a physical acceleration to the MEMS accelerometer package. A MEMS accelerometer is first placed in a first orientation (e.g., where the proof mass is spatially above the sense electrodes). While the proof mass will initially experience some amount of acceleration due to gravity, no other external or internal force is acting on the proof mass. Once a voltage is applied to the test electrodes that are present spatially below the proof mass, an electromagnetic force is exerted onto the proof mass. The movement of particular portions of the proof mass are detected at the sense electrodes and measured at the appropriate terminals within the MEMS accelerometer. The sequence of applying the electromagnetic force with the test electrodes and measuring the movement of the proof mass is repeated with the MEMS accelerometer in a second orientation (e.g., one that is opposite from the first orientation where the proof mass is spatially below the sense electrodes). In some implementations, multiple voltages are applied and measurements are taken at each of the MEMS accelerometer orientations. A transfer characteristic of the MEMS accelerometer can be calculated using information from the tests, including the voltages applied to the test electrodes (in all orientations of the proof mass) and the output signals from the sense electrodes (in all orientations of the proof mass).

The method of using an electromagnetic force to apply an acceleration greater than 1 G to the proof mass can be repeated as many times as necessary (i.e., multiple orientations with multiple applied voltages to the test electrodes) until a desired output (e.g., a transfer characteristic) can be obtained. With the transfer characteristic, conclusions may be drawn on the conformity, operability, functionality, and performance of the MEMS accelerometer. End-use applications (e.g., automotive utility) may be envisaged based on particular characteristics of the test MEMS accelerometer (e.g., acceleration limit, failure point/mode).

Additional modifications to the method can be made. For example, there may be multiple test electrodes within the MEMS accelerometer, which are connected to their own independent power sources that can allow for the application of multiple voltages simultaneously or consecutively. Feedback systems (e.g., control loops) may also be implemented that are able to precisely tune/modify the test electrode voltages until a particular sense signal is obtained.

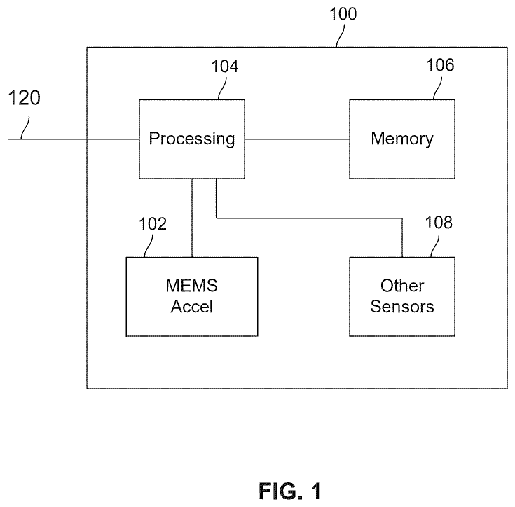

FIG. 1 shows an illustrative MEMS system 100 in accordance with an embodiment of the present disclosure. Although particular components are depicted in FIG. 1, it will be understood that other suitable combinations of the MEMS, processing components, memory, and other circuitry may be utilized as necessary for different applications and systems. In accordance with the present disclosure, the MEMS system may include a MEMS accelerometer 102 as well as additional sensors 108. Although the present disclosure will be described in the context of signals received from particular designs of MEMS accelerometers (e.g., out-of-plane or z-axis sensing), it will be understood that test electrodes may apply an electromagnetic acceleration to a proof mass within a MEMS accelerometer in any suitable MEMS accelerometer design, such as in-plane test electrodes applying acceleration forces within an in-plane x-axis or y-axis.

Processing circuitry 104 may include one or more components providing processing based on the requirements of the MEMS system 100. In some embodiments, processing circuitry 104 may include hardware control logic that may be integrated within a chip of a sensor (e.g., on a base substrate of a MEMS accelerometer 102 or other sensors 108, or on an adjacent portion of a chip to the MEMS accelerometer 102 or other sensors 108) to control the operation of the MEMS sensor 102, or other sensors 108, and perform aspects of processing for the MEMS accelerometer 102 or the other sensors 108. In some embodiments, the MEMS accelerometer 102 and other sensors 108 may include one or more registers that allow aspects of the operation of hardware control logic to be modified (e.g., by modifying a value of a register). In some embodiments, processing circuitry 104 may also include a processor such as a microprocessor that executes software instructions (e.g., that are stored in memory 106). The microprocessor may control the operation of the MEMS accelerometer 102 by interacting with the hardware control logic and processing signals received from MEMS accelerometer 102. The microprocessor may interact with other sensors 108 in a similar manner. In some embodiments, some or all of the functions of the processing circuitry 104, and in some embodiments, of memory 106, may be implemented on an application specific integrated circuit (“ASIC”) and/or a field programmable gate array (“FPGA”).

Although in some embodiments (not depicted in FIG. 1), the MEMS accelerometer 102 or other sensors 108 may communicate directly with external circuitry (e.g., via a serial bus or direct connection to sensor outputs and control inputs), in an embodiment the processing circuitry 104 may process data received from the MEMS accelerometer 102 and other sensors 108 and communicate with external components via a communication interface 110 (e.g., a serial peripheral interface (SPI) or 12C bus, in automotive applications a controller area network (CAN) or Local Interconnect Network (LIN) bus, or in other applications a suitably wired or wireless communications interface as is known in the art). The processing circuitry 104 may convert signals received from the MEMS accelerometer 102 and other sensors 108 into appropriate measurement units (e.g., based on settings provided by other computing units communicating over the communication interface 110) and perform more complex processing to determine measurements such as orientation or Euler angles, and in some embodiments, to determine from sensor data whether a particular activity (e.g., walking, running, braking, skidding, rolling) is taking place. In some embodiments, some or all of the conversions or calculations may take place on the hardware control logic or other on-chip processing of the MEMS accelerometer 102 or other sensors 108.

In some embodiments, certain types of information may be determined based on data from multiple MEMS accelerometers 102 and other sensors 108 in a process that may be referred to as sensor fusion. By combining information from a variety of sensors it may be possible to accurately determine information that is useful in a variety of applications, such as image stabilization, navigation systems, automotive controls and safety, dead reckoning, remote control and gaming devices, activity sensors, 3-dimensional cameras, industrial automation, and numerous other applications.

In embodiments of the present disclosure, the MEMS accelerometer 102 may function within devices exposed to accelerations greater than 1 G (e.g., multiples or orders of magnitude greater than 1 G). Testing of MEMS accelerometers 102 at levels higher than 1 G typically requires the utilization of bulky and expensive physical test machines that are capable of physically accelerating the proof masses within the MEMS accelerometer 102. In the current context, the MEMS accelerometer 102 May 1 G test electrodes that can electromagnetically accelerate the proof mass to levels greater than 1 G, and sense electrodes that can sense the movement of particular portions of the proof mass induced by the electromagnetic force. With such electrodes, devices that contain these MEMS accelerometers 102 may not require the use of physical test machines and equipment to determine the sensitivity, performance, functionality, and other characteristics of the MEMS accelerometers 102.

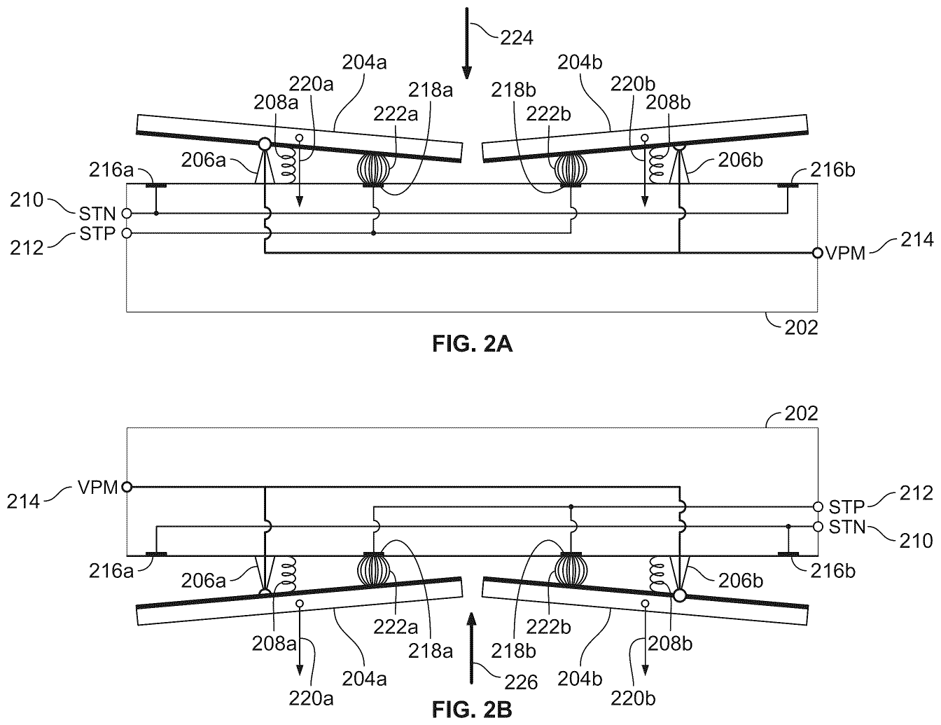

FIG. 2A depicts an exemplary MEMS accelerometer whereby its response is measured in a first orientation relative to gravity at accelerations>1 G during a physical acceleration on a test machine. Although FIG. 2A will be described in the context of a particular application and system components, it will be understood that the present disclosure may be utilized with a variety of other devices. The MEMS accelerometer 202 may have a number of different configurations and components. In an exemplary embodiment, the MEMS accelerometer 202 includes differential proof masses 204a-b that is affixed to respective anchor 206a-b. The compliance/resistance to out-of-plane movement of the proof masses 204a-b is represented by spring constants 208a-b. A voltage 214 is applied to the proof mass via a power source (not shown). The movement of the proof masses 204a-b generates respective sense signals 222a-b caused by the external acceleration forces and is sensed at the negative sense electrodes 216a-b and positive sense electrodes 218a-b, and the respective electrical charge differential measured at the negative terminal pad 210 and positive terminal pad 212. The charge differential is representative of a particular physical distance between portions of the proof masses 204a-b and the sense electrodes (216a-b, 218a-b). The applied acceleration due to gravity 220a-b is in a downward direction on the proof mass 204a-b. In cases where the MEMS accelerometer encounters other physical accelerations (e.g., when acceleration is applied using a test machine), those external forces may not be in the same direction as the gravitational acceleration 220a-b. Therefore, the overall applied acceleration 224 on the proof masses 204a-b is the additive combination of all external acceleration forces, including gravitational acceleration 220.

While there may be two proof masses 204a-b shown in FIG. 2A, any number of proof masses 204 may be included within a single MEMS accelerometer (e.g., one for each spatial axis). Each proof mass 204 may have its own unique geometry, design, support structures, thickness, and configuration. The compliance of the proof mass 204 (x, y, or z-axis) is dependent on the configuration of the MEMS accelerometer 202, the direction of the applied force, and how the proof mass 204 is positioned within the device. In some embodiments, there may be one or multiple sense springs that suspend the proof mass 204 in its own spatial plane and provide a restoring force to return it back to its resting position once external accelerations/forces have been removed. The proof mass 204 is supported by at least one anchor 206. The attachment point of the anchor 206 to the proof mass 204 may be at any location along the proof mass 204. The movement of the proof mass 204 and the generated sense signal 222 within the MEMS accelerometer 202 may be determined using one or more sense electrodes (e.g., 216a-b, 218a-b) that are capable of measuring changes in a particular value (e.g., capacitance). In order to measure these changes, a charge is induced on the proof masses 204a-b via a voltage 214 from a power source (not shown). The voltage is delivered to the proof masses 204a-b via internal or external electrical pathways (e.g., conduits, wires) and enters via the attachment point between the proof mass 204 and the anchor 206.

The anchors 206a-b are fixed, immovable structure on the substrate (not shown) that act as attachment points for the proof mass 204a-b (or other device components), thus allowing the proof masses 204a-b to have controlled and predictable movements once an external force is applied to the system. The anchors 206 also serve to provide rigidity and structural integrity to the entire MEMS accelerometer 202. While only two anchors 206a-b are depicted within FIG. 2A., any number of anchors 206 may be included within a single MEMS accelerometer 202, each with their own unique geometry (e.g., plate, beam), design, material, thickness, and configuration. A voltage is applied to the proof masses 204a-b through the attachment point between the proof masses 204a-b and the respective anchor 206a-b.

The spring constants 208a-b are a representation of the compliance/resistance to out-of-plane movement of the proof mass 204. While there may be a variety of springs and masses within the MEMS accelerometer 202 (not depicted in FIG. 2A), the spring constants 208a-b are not a physical component of the device. The value of this spring constant is directly related to the properties of the proof mass 204a-b such as its geometry, design, thickness, material (including coatings), the configuration relative to the anchors 206a-b, and interconnecting springs and masses. The higher the spring constant, the stiffer the proof mass 204, which indicates that it can better withstand larger external forces. Conversely, lower spring constants means the proof mass 204 is more flexible and allows for a greater displacement when exposed to external forces. The employment of proof masses 204 that have spring constants 208 high enough to withstand the gravitational acceleration 220 may occur in particular embodiments.

The negative terminal pad 210 and positive terminal pad 212 of the sense electrodes correspond to locations where measurements are taken (e.g., measurements due to displacement of the proof masses 204a-b relative to the sense electrodes 216a-b and 218a-b). The difference in measurement values (e.g., charge differential) that may be present at these pads represents a particular physical distance between portions of the proof mass 204a-b and the sense electrodes (216a-b, 218a-b). Strong enough accelerations (e.g., external forces, gravity) will induce a movement in the proof mass 204 that changes the distance between a particular portion of the proof masses 204a-b and the sense electrodes (216a-b, 218a-b), which in turn alters the differential (e.g., charge differential) that is measured between the negative terminal pad 210 and positive terminal pad 212. There may be multiple sets of terminal pads (210, 212) within a single MEMS accelerometer 202. The terminal pads (210, 212) may vary in size, shape, configuration, material (e.g., aluminum, gold, platinum) and may have prongs or other suitable attachment fixtures to more easily perform measurements. The type of measurements obtained from these pads may vary (e.g., voltage, capacitance, inductance) and the signal may be constant, variable, or a combination thereof (e.g., AC, DC).

The voltage 214 that is applied to the proof masses 204a-b is supplied by a power source (not shown). The power source may be external or internal to the MEMS accelerometer 202. The specific applied value, frequency, polarity, duty cycle, type (AC, DC), or any other characteristic of the voltage may vary between not only MEMS accelerometers 202, but also individual proof masses 204.

Negative sense electrodes 216a-b and positive sense electrodes 218a-b are present within the MEMS accelerometer 202. It will be understood the particular naming of electrodes as “positive” or “negative” is simply based on which electrodes should experience changes in capacitance in a similar manner, e.g., based on the movement of the proof masses 204a-b. While there may be two pairs of sense electrodes shown in FIG. 2A, any number of sense electrodes may be included within a single MEMS accelerometer 202. Each sense electrode (216, 218) may have its own geometry, location, material, coating, and general configuration that varies across MEMS accelerometers 202. When the charged proof mass 204 experiences an external acceleration (e.g., an applied acceleration), the movement of particular portions of the charged proof mass 204 causes a sense signal 222 to be produced that is detected differentially at the negative sense electrode 216a-b and the positive sense electrode 218a-b. Larger movements of the proof mass 204a-b may lead to larger changes in the sense signals 222a-b (e.g., depicted for the positive sense electrodes 218a-b, based on increase of capacitance due to the particular force being sensed, but similarly experienced as a decreasing capacitance at negative sense electrodes 216a-b). The sense signals 222 generated at the sense electrodes (216, 218) travel through electrical pathways to the respective terminal pads (210, 212) where the sense signal 222 is measured.

An applied gravitational acceleration 220 is constantly being exerted onto the MEMS accelerometer 202 during use. Placing the MEMS accelerometer 202 in a face-up orientation relative to gravity (i.e., where the proof mass 204 is spatially above the sense electrodes (216, 218)), the gravitational acceleration 220 is equivalent to 1 G or 9.81 m/s². Placing the MEMS accelerometer in a face-down orientation relative to gravity (i.e., where the proof mass 204 is spatially below the sense electrodes (216, 218)), the gravitational acceleration 220 is equivalent to −1 G or −9.81 m/s². Thus, by flipping the orientation of the MEMS accelerometer 202, the acceleration as sensed by the MEMS accelerometer 202, is changed by an absolute value of 2 G. The overall acceleration 224 being applied to the MEMS accelerometer 202 is equivalent to the additive combination of all external acceleration forces acting on the MEMS accelerometer 202. In cases where there are no other external accelerations being applied to the system, the gravitational acceleration 220 would be equivalent to the overall applied acceleration 224 (in both magnitude and direction). In cases where there are other external acceleration forces being applied (e.g., during the application of physical accelerations in a test machine), the overall applied acceleration 224 will be the combination of the gravitational acceleration 220 and the other external accelerations. It is possible that both the magnitude and direction of the overall applied acceleration 224 are different than that of the gravitational acceleration 220. For example, a gravitational force of 1 G and an external acceleration force of 19 G being applied to the MEMS accelerometer would yield an overall applied acceleration of 20 G. Another example is a gravitational force of 1 G and an external acceleration force of −19 G being applied to the MEMS accelerometer would yield an overall applied acceleration of −18 G.

FIG. 2B depicts an exemplary MEMS accelerometer whereby its response is measured in a second orientation, that is opposite the first orientation, at accelerations>1 G during a physical acceleration on a test machine. This MEMS accelerometer 202 is similar to and functions in a similar manner as that of the MEMS accelerometer 202 in FIG. 2A except that it is in the opposite orientation (i.e., where the proof mass 204 is spatially below the sense electrodes (216, 218)).

The numbered elements of FIG. 2B are identical to and function in an identical manner as the components of FIG. 2A. However, the overall applied acceleration 226 is in the opposite direction and of different magnitude due to the opposite orientation of the MEMS accelerometer 202 (i.e., where the proof mass 204 is spatially below the sense electrodes (216, 218)). The external acceleration forces being applied (e.g., during the application of physical accelerations in a test machine) are stronger and in the opposite direction of the gravitational acceleration 220, thus causing the overall applied acceleration 226 to be opposite in direction than the gravitational acceleration 220. By changing the orientation of the MEMS accelerometer 202, it is possible to alter both the magnitude and direction of the overall applied acceleration 226. In this manner, a test machine is able to apply accelerations to the MEMS accelerometer and a resulting sensed value can be determined.

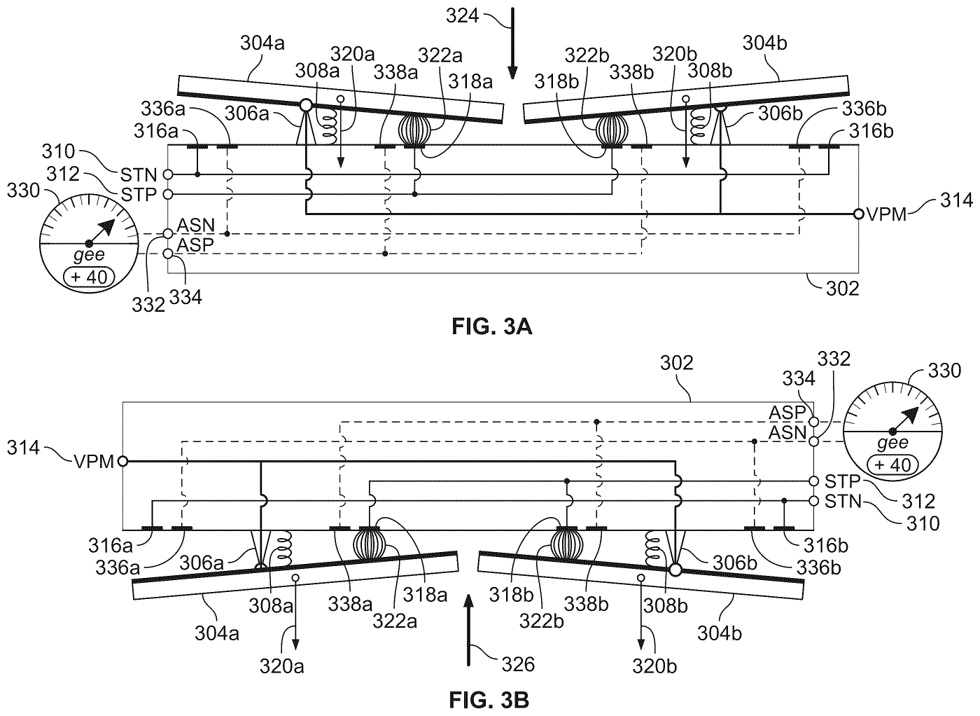

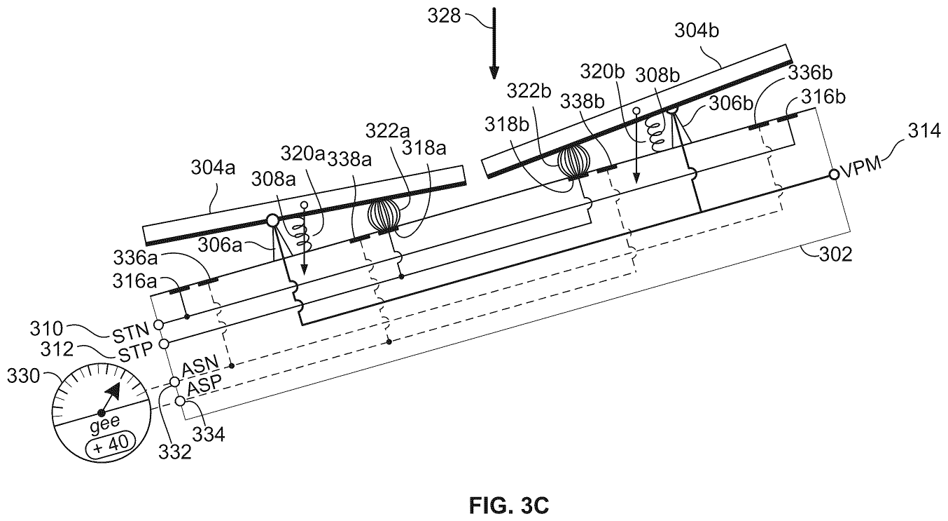

FIG. 3A depicts an exemplary MEMS accelerometer whereby its response is measured in a first orientation relative to gravity at accelerations>1 G during an electromagnetic acceleration test in accordance with an embodiment of the present disclosure. This MEMS accelerometer is similar to and functions in a similar manner as that of the current mirror in FIG. 2A. However, a power source 330 is added to the accelerometer that provides power at the negative input pad 332 and positive input pad 334 of the test electrodes (336, 338). Both the negative test electrode 336 and the positive test electrode 338 work in unison to subject particular portions of the proof mass 304 to electromagnetic forces, which may be equivalent in magnitude and direction as the physical acceleration forces the proof mass 304 would be subjected to in a physical acceleration test machine. Through the use of electromagnetic forces generated by the test electrodes (336, 338), no physical acceleration test machine is required to test the response of the MEMS accelerometer at accelerations>1 G.

The MEMS accelerometer 302 in FIG. 3A is similar to and functions in a similar manner as that of the MEMS accelerometer 202 in FIG. 2A (e.g., proof mass 304 corresponds to proof mass 204, anchor 306 corresponds to anchor 206, spring constant 308 corresponds to spring constant 208, negative terminal pad of sense electrode 310 corresponds to negative terminal pad of sense electrode 210, positive terminal pad of sense electrode 312 corresponds to positive terminal pad of sense electrode 212, proof mass voltage 314 corresponds to proof mass voltage 214, negative sense electrode 316 corresponds to negative sense electrode 216, positive sense electrode 318 corresponds to positive sense electrode 218, gravitational acceleration 320 corresponds to gravitational acceleration 220, sense signal 322 corresponds to sense signal 222, and overall applied acceleration 324 corresponds to overall applied acceleration 224). However, a power source 330 has been included within the MEMS accelerometer that is capable of supplying power to the negative input pad 332 and positive input pad 334 of the test electrodes (336, 338). The power source 330 may be external or internal and may supply a power that is AC, DC, or a combination thereof. The supplied power may have any frequency, duty cycle, amplitude, voltage sweep, or any other characteristic. The supplied power induces a particular electromagnetic force (and thus acceleration of the proof mass 304) that is associated with an expected linear acceleration, depicted as an example of 40 G for power source 330. The supplied power travels through electrical pathways to the respective input pads (332, 334), where additional electrical connections deliver the power to the test electrodes (336, 338). The power source 330 is sufficiently strong to provide enough power to the MEMS accelerometer 302 to achieve the acceleration values required for testing purposes.

Negative test electrodes 336 and positive test electrodes 338 are present within the MEMS accelerometer 302. While there may be two pairs of test electrodes shown in FIG. 3A, any number of test electrodes (336, 338) may be included within a single MEMS accelerometer 302. Each test electrode (336, 338) may have its own geometry, location, material, coating, and general configuration that varies across MEMS accelerometers 302. The test electrodes (336, 338) apply an electromagnetic force to particular portions of each proof mass 304. The electromagnetic force causes the proof mass 304 to undergo movements at accelerations greater than 1 G, with changes in the applied signal corresponding to expected applied accelerations. In this manner the applied acceleration 324 corresponds to the force of gravity plus the acceleration that is expected to be applied by the test electrodes 336a-b and 338a-b, which are in turn based on the applied signal form the power source 330.

In some embodiments, multiple sequences of applied signals can be applied by the power source 330 and test electrodes 336a-b and 338a-b at each orientation of the accelerometer 302. For example, each applied signal may correspond to an expected resulting linear acceleration applied to the proof masses 304a and 304b. By iteratively applying multiple signals over different accelerations and ranges of accelerations, a response of the particular accelerometer (e.g., sensitivity at different acceleration values, etc.) can be determined.

When the proof masses 304a-b experiences the net acceleration 324, the movement of particular portions of the proof masses 304a-b causes sense signals 322a-b to be produced that may be detected at the negative sense electrodes 316a-b and the positive sense electrodes 318a-b. The sense signals 322a-b generated at the sense electrodes (316a-b, 318a-b) travel through electrical pathways to the respective terminal pads (310, 312) where the signal is measured. Note that the strength/intensity of the sense signal 322 may be different depending on where the signal is being generated (i.e., negative sense electrode 316 or positive sense electrode 318). The electrical sense signal 322 can be converted mathematically (e.g., using calibration curves) to an acceleration value, which can then be utilized (in conjunction with other values such as the supplied voltage 330) for evaluating the sensitivity and performance of the MEMS accelerometer 302. For example, if the MEMS accelerometer 302 is not able to replicate an acceleration value that is similar or identical to the effectively applied overall acceleration value, then the tested MEMS accelerometer 302 may be deemed inoperative, placed into a use category for a particular application (e.g., consumer vs. navigation), or otherwise undergo further processing. Through the use of these test electrodes (336, 338), it is possible to subject the proof mass 304 to acceleration forces>1 G without the use of physical acceleration machines and equipment.

FIG. 3B depicts an exemplary MEMS accelerometer whereby its response is measured in a second orientation, that is opposite the first orientation, at accelerations>1 G during an electromagnetic acceleration test in accordance with an embodiment of the present disclosure. This MEMS accelerometer 302 is similar to and functions in a similar manner as that of the MEMS accelerometer in FIG. 3A except that it is in the opposite orientation (i.e., where the proof mass 304 is spatially below the sense electrodes (316, 318)).

The numbered elements of FIG. 3B are identical to and function in an identical manner as the components of FIG. 3A. However, the overall applied acceleration 326 is in the opposite direction and of different magnitude due to the opposite orientation of the MEMS accelerometer 302 (i.e., where the proof masses 304a-b are spatially below the sense electrodes (316a-b, 318a-b) and test electrodes (336a-b, 338a-b)). The electromagnetic forces being applied by the test electrodes (336, 338) are stronger and in the opposite direction of the gravitational acceleration 320, thus causing the overall applied acceleration 326 to be opposite in direction than the gravitational acceleration 320. By changing the orientation of the MEMS accelerometer 302, it is possible to alter both the magnitude and direction of the overall applied acceleration 326. Because the force of gravity is the same but in an opposite direction than in the configuration of FIG. 3A, the gravitational force of 1 G can be used to normalize or calibrate the overall acceleration measurement due to the applied force from the test electrode, for example, based on a difference in the sensed force due to the 2 G difference at the different orientations. Multiple applied accelerations may be iteratively provided from power source 330 and test electrodes 336a-b and 338a-b to determine the response of the proof masses 304a-b to different applied linear accelerations. Using the values for the applied voltages, the corresponding expected acceleration values, and the sensed signals, the accuracy and sensitivity of the accelerometer 302 at a variety of different accelerations and ranges of accelerations can be determined by direct measurement, interpolation, determination of a transfer function, in other suitable manners, and through combinations thereof.

In some embodiments, equal and opposite forces, or multiple iterations of equal and opposite forces, can be applied to the proof masses 304a-b via the test electrodes 336a-b and 338a-b. In some embodiments, based on the known difference in acceleration due to gravity at different orientations, a first sense value can be determined due to a first applied voltage at the first orientation and a variable voltage can be applied at the second orientation until the same sense value is achieved at the second orientation. In this manner, the difference between the two applied voltages should correspond to the change in gravitational force.

A sensed value for acceleration due to an applied test voltage at test electrodes may vary between different designs or even different components of a similar design. In some embodiments, differences in measured scaling, accuracy, and/or sensitivity can be used to modify the operation of the accelerometer in the field, for example by updating scaling values, filters, gains, and other similar values in the accelerometer. In designs where a power source 330 suitable for applying the test voltages is a component of the MEMS accelerometer or otherwise available at the MEMS accelerometer, testing may be performed over time such that values are updated as components wear or other conditions (e.g., temperature, end-use part stresses, etc.) are changed over time.

In some embodiments, a first voltage applied at the first orientation and the second voltage applied at the second orientation are the same, and additional voltages are applied at each orientation in an iterative fashion to measure differences over a range of acceleration values. For example, an accelerometer design may have a greater accuracy and/or sensitivity within certain ranges of accelerations. Accordingly, multiple accelerations can be applied at each orientation, for example in each of low acceleration conditions (e.g., 2 G, 3 G, etc.), higher acceleration conditions (e.g., 30 G, 35 G, 30 G, etc.), or even higher acceleration conditions depending on the end-use application and likely acceleration ranges that require measurement. The applied accelerations may be equal and opposite, may be adjusted as described herein to achieve equal output sense signals, other applied acceleration patterns, and combinations thereof.

A transfer function may be determined based on performing the multiple stages of applied forces and corresponding measurements, providing a sensitivity and/or other characterizations of the accelerometer response at different frequencies. This information may then be used to adjust the operation of the accelerometer such as by changing scaling, gain, filter or other values, to set maximum values of accelerations to measure, to identify the accelerometer as non-conforming, or to utilize the accelerometer as suitable for particular applications. In an example of identifying the accelerometer for particular applications, an accelerometer with a lower sensitivity to high acceleration values may be limited to use in simple consumer applications, rather than being used in navigation applications such as in vehicles.

FIG. 3C depicts an exemplary MEMS accelerometer whereby its response is measured in a third orientation, that is a tilted version of the first orientation, at accelerations>1 G during an electromagnetic acceleration test in accordance with an embodiment of the present disclosure. This MEMS accelerometer 302 is similar to and functions in a similar manner as that of the MEMS accelerometer in FIG. 3A except that it is in a tilted orientation (e.g., 30° relative to a flat surface).

The numbered elements of FIG. 3C are identical to and function in an identical manner as the components of FIG. 3A. However, the overall applied acceleration 328 is of a different magnitude due to the tilted orientation of the MEMS accelerometer 302 (e.g., 30° relative to a flat surface). Despite the same electromagnetic forces being applied by the test electrodes (336, 338), due to the angle that the gravitational acceleration 320 is acting on the proof mass 304, the overall applied acceleration 328 is decreased. By changing the orientation angle of the MEMS accelerometer 302, it is possible to alter the magnitude (and in some cases also the direction) of the overall applied acceleration 328. In this manner, the acceleration test routine can be applied at a variety of orientations, e.g., not just at opposite orientations as depicted in FIG. 3A and 3B.

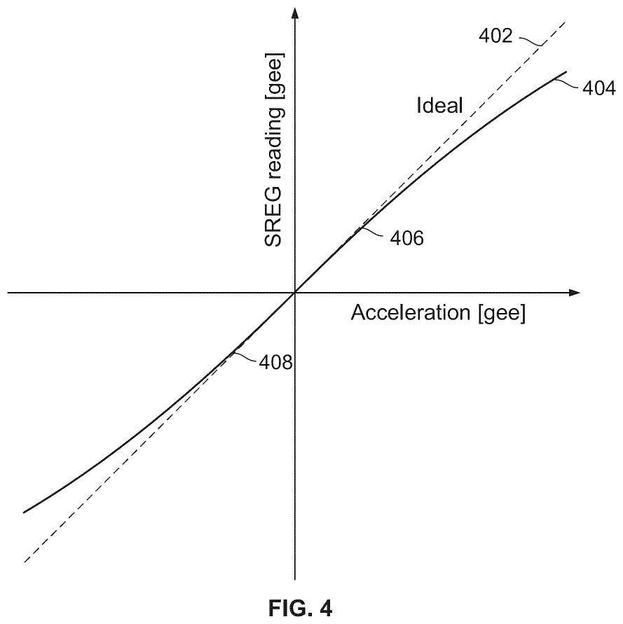

FIG. 4 depicts a plot of an accelerometer transfer function that conveys the relationship between the measured acceleration output and the actual acceleration in accordance with an embodiment of the present disclosure. The abscissa is actual applied acceleration and is in units of gee (i.e., G). The ordinate is the calculated acceleration that is obtained by measuring the sense signal at the terminal pads of the sense electrodes and is in units of gee (i.e., G). Such a transfer function can be generated using iterative application of applied accelerations from test electrodes as described herein, and interpolating the actual sense results.

The ideal correlation 402 between the actual applied acceleration and the calculated acceleration is plotted using a dashed line. In ideal circumstances, the two values would be identical. As the actual applied acceleration increases/decreases, the calculated acceleration from the measurements on the MEMS accelerometer would concomitantly and proportionally increase/decrease.

Real-time measurements on the MEMS accelerometer produce a non-ideal correlation 404 between the actual applied acceleration and the calculated acceleration. Due to a variety of factors (e.g., tolerance deficiencies in manufacturing, defective components), the two values deviate from one another at a particular acceleration value (i.e., the deviation point). Both the positive deviation point 406 and the negative deviation point 408 may vary between MEMS accelerometers. It may be possible to utilize the deviation point (406, 408) to set operating parameters for the MEMS accelerometers (e.g., gain, filters, scaling, etc.), to place the MEMS accelerometers into particular categories (e.g., non-conforming, conforming), to determine the inherent acceleration limit (and in some cases the failure limit/mode) for that particular MEMS accelerometer, and to identify the best application (e.g., use in vehicles) for that particular MEMS accelerometer. Note that while FIG. 4 depicts a symmetrical deviation, the shape and magnitude of the ideal correlation 402 and non-ideal correlation 404 curves may vary between MEMS accelerometers (e.g., the ideal correlation 402 and non-ideal correlation 404 are identical under positively applied accelerations, but deviate quickly under negatively applied accelerations). Similarly, there may be embodiments where a positive deviation point 406 or a negative deviation point 408 does not exist (i.e., only one deviation point exists for the particular MEMS accelerometer).

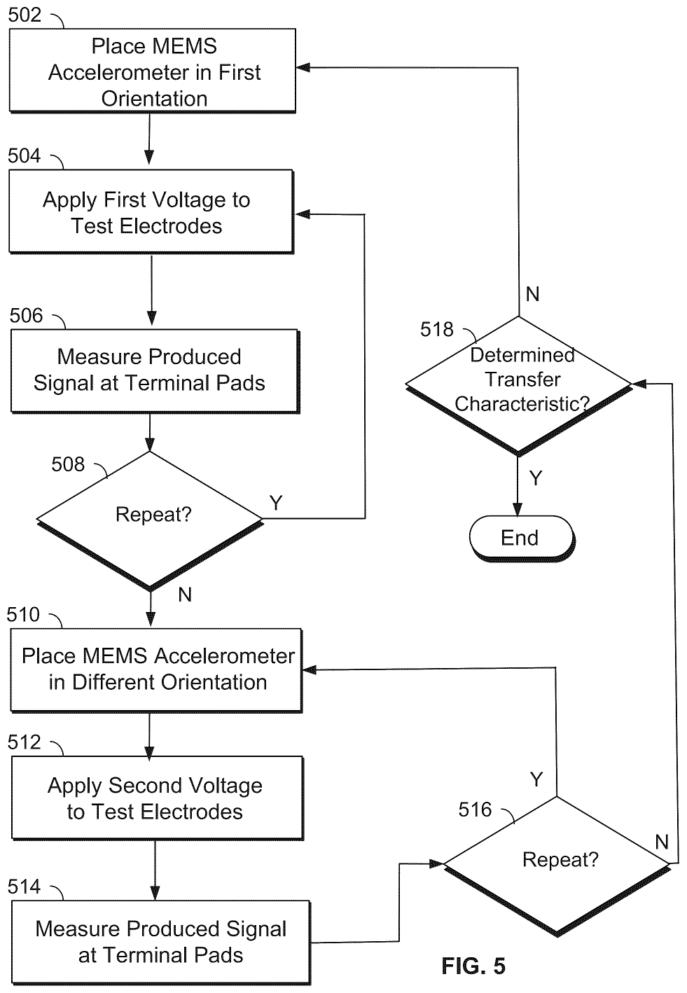

FIG. 5 depicts exemplary steps of determining the response of a MEMS accelerometer at accelerations>1 G during an electromagnetic acceleration test in accordance with an embodiment of the present disclosure. Although particular steps are depicted in a certain order for FIG. 5, steps may be removed, modified, or substituted, and additional steps may be added in certain embodiments, and in some embodiments, the order of certain steps may be modified.

Processing starts at step 502, where the MEMS accelerometer is placed in a first orientation (e.g., where the proof mass is spatially above the sense electrodes). In this orientation, gravitational acceleration exerts a force onto the proof mass. Until the test electrodes are activated, there is no other external or internal force acting on the charged proof mass to induce movement. Once the MEMS accelerometer is in the first orientation, processing may continue to step 504.

A first voltage is applied to the test electrodes at step 504. A particular first voltage is applied to the input pads of the test electrodes from an internal or external power supply. Electrical connections deliver the voltage to the test electrodes. The potential at the test electrodes applies an electromagnetic force to the charged proof mass, which in turn elicits a movement (and thus acceleration) of particular portions of the proof mass. These accelerations are at values greater than 1 G. The movements of the proof mass may be resisted or strengthened by the direction of gravitational acceleration. Processing may continue to step 506.

At step 506, the sense signal, produced by the movement of particular portions of the proof mass, is measured. Movements of particular portions of the proof mass generate a sense signal at the sense electrodes. The sense electrodes deliver this sense signal through electrical connections to the terminal pads of the sense electrodes. The sense signal can be converted mathematically (e.g., via calibration plots) into transfer characteristics or other values (e.g., accelerations), which may be used for further analyses. Processing may continue to step 508.

At step 508, it may be determined whether to perform additional steps of applying the electromagnetic acceleration signal via the test electrodes at the first orientation. As described herein, multiple different accelerations may be applied and measurements performed to assess sensitivity or other parameters at different acceleration values and within different frequency ranges. In some instances this iterative processing may be performed as part of a predetermined procedure or in other instances more testing may be performed based on initial results of previous iterations (e.g., based on an initial reading falling outside of certain thresholds). If additional testing is to be performed at the first orientation, processing returns to step 504. If no more testing is to be performed at the first orientation, processing can continue to step 510.

At step 510, the MEMS accelerometer is now placed in a different orientation than the first orientation (e.g., where the proof mass is spatially below the sense electrodes). In this orientation, gravitational acceleration still exerts a force onto the proof mass. Until the test electrodes are activated, there is no other external or internal force acting on the charged proof mass to induce movement. Once the MEMS accelerometer is in this different orientation, processing may continue to step 512.

A second voltage is applied to the test electrodes at step 512. A particular second voltage is applied to the input pads of the test electrodes from an internal or external power supply. Electrical connections deliver the voltage to the test electrodes. The potential at the test electrodes applies an electromagnetic force to the charged proof mass, which in turn elicits a movement (and thus acceleration) of particular portions of the proof mass. These accelerations are at values greater than 1 G. The movements of the proof mass are also based on the changed direction of gravitational acceleration. Processing may continue to step 514.

At step 514, the sense signal, produced by the movement of particular portions of the proof mass, is measured. Movements of particular portions of the proof mass generate a sense signal at the sense electrodes. The sense electrodes deliver this sense signal through electrical connections to the terminal pads of the sense electrodes. The sense signals produced in this different orientation may be similar, different, or identical to the sense signals produced when the MEMS accelerometer was placed in the first orientation. The sense signal can be converted mathematically (e.g., via calibration plots) into transfer characteristics or other values (e.g., accelerations), which may be used for further analyses. Processing may continue to step 516.

At step 516, it may be determined whether to perform additional steps of applying the electromagnetic acceleration signal via the test electrodes at the second orientation. As described herein, multiple different accelerations may be applied and measurements performed to assess sensitivity or other parameters at different acceleration values and within different frequency ranges. In some instances this iterative processing may be performed as part of a predetermined procedure or in other instances more testing may be performed based on initial results of previous iterations (e.g., based on an initial reading falling outside of certain thresholds). If additional testing is to be performed at the second orientation, processing returns to step 510. If no more testing is to be performed at the first orientation, processing can continue to step 518.

The transfer characteristic of the MEMS accelerometer based on the testing is performed at step 518. Multiple values may be utilized during this step to determine the transfer characteristic. For example, the first voltages applied and the produced signals when the MEMS accelerometer was in the first orientation, the second voltages applied and the produced signals when the MEMS accelerometer was in the different orientation, and other values (e.g., temperature, etc.) may be utilized. With these values, and any combination thereof, the sensitivity, performance, and overall functionality of the MEMS accelerometer may be determined. Further, the MEMS accelerometer may be updated, the MEMS accelerometers may now be placed into particular categories (e.g., non-conforming, conforming), the inherent acceleration limit (and in some cases the failure limit/mode) for that particular MEMS accelerometer may be determined, and the best application for that particular MEMS accelerometer may be identified. If the characteristics of the MEMS accelerometer are fully evaluated (e.g., acceptable performance thresholds are met), then processing ends. If the characteristics of the MEMS accelerometer are not fully evaluated (e.g., more information using other voltages or different orientations is desired), then the process may proceed back to step 508 where additional testing can be performed.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art. consistent with the following claims.

What is claimed is:

1. A method for testing a response of a microelectromechanical system (MEMS) accelerometer to accelerations greater than 1 G, comprising:
placing the MEMS accelerometer at a first orientation relative to gravity, wherein in the first orientation a proof mass of the MEMS accelerometer is located above a sense electrode of the MEMS accelerometer and a test electrode of the MEMS accelerometer, and wherein the proof mass experiences a force of gravity at the first orientation;
applying a first voltage to the test electrode, wherein the first voltage causes a first movement of the proof mass;
measuring, by the sense electrode, a first sense signal corresponding to the force of gravity and the first movement of the proof mass;
placing the MEMS accelerometer at a second orientation relative to gravity that is opposite the first orientation, wherein in the second orientation the proof mass is located below the sense electrode and the test electrode, and wherein the proof mass experiences an equal and opposite force to the force of gravity at the second orientation of the MEMS accelerometer;
applying, to the test electrode, a second voltage to the test electrode, wherein the second voltage causes a second movement of the proof mass;
measuring, by the sense electrode, a second sense signal corresponding to the equal and opposite force and the second movement of the proof mass; and
determining, based on the first voltage, the second voltage, the first sense signal, and the second sense signal, a sensitivity of the MEMS accelerometer to a first acceleration value greater than 1 G.

2. The method of claim 1, wherein the first voltage and the first sense signal are associated with the first acceleration value, and wherein applying the second voltage comprises modifying the second voltage until the second sense signal indicates that the second movement is equal to the first movement.

3. The method of claim 2, wherein the first voltage is a fixed voltage value associated with the first acceleration value, and wherein a first value of the first sense signal varies based on characteristics of the MEMS accelerometer under test.

4. The method of claim 3, wherein the second voltage is modified until a second value of the second sense signal corresponds to the first value of the first sense signal after removing effects of gravity.

5. The method of claim 4, wherein the sensitivity is determined based on the first voltage and on the modified second voltage.

6. The method of claim 1, wherein the first voltage and the second voltage are a same first voltage value, further comprising:
applying, to the test electrode while the MEMS accelerometer is at the first orientation, a third voltage to the test electrode having a second voltage value, wherein the third voltage causes a third movement of the proof mass;
measuring, by the sense electrode, a third sense signal corresponding to the force of gravity and the third movement of the proof mass;
applying, to the test electrode while the MEMS accelerometer is at the second orientation, a fourth voltage to the test electrode having the second voltage value, wherein the fourth voltage causes a fourth movement of the proof mass; and
measuring, by the sense electrode, a fourth sense signal corresponding to the force of gravity and the fourth movement of the proof mass, wherein the determining the sensitivity of the MEMS accelerometer to the first acceleration value is further based on the first voltage value, the second voltage value, the third sense signal, and the fourth sense signal.

7. The method of claim 6, where the method is repeated one or more times to add a set of additional voltages and corresponding sense signals.

8. The method of claim 7, further comprising determining a transfer characteristic of the accelerometer over a range of acceleration values over 1 G based on the first sense signal, the second sense signal, the third sense signal, the fourth sense signal, the first voltage value, and the second voltage value.

9. The method of claim 8, further comprising identifying the MEMS accelerometer as non-conforming based on the transfer characteristic.

10. The method of claim 8, further comprising identifying an acceleration limit for the MEMS accelerometer based on the transfer characteristic.

11. The method of claim 8, further comprising identifying a suitable end-use application for the MEMS accelerometer based on the transfer characteristic.

12. The method of claim 8, further comprising identifying a failure mode of the MEMS accelerometer based on the transfer characteristic.

13. The method of claim 1, wherein applying each of the first voltage to the test electrode and the second voltage to the test electrode each comprise applying a voltage from a source external to the MEMS accelerometer to an input pad of the MEMS accelerometer that is connected to the test electrode.

14. The method of claim 1, wherein applying each of the first voltage to the test electrode and the second voltage to the test electrode each comprise generating a voltage within the MEMS accelerometer and applying the generated voltage to the test electrode.

15. A system for testing a response of a microelectromechanical system (MEMS) accelerometer to accelerations greater than 1 G, comprising:
a proof mass;
a sense electrode;
a test electrode;
a power source; and
processing circuitry, wherein the processing circuitry is configured to:
apply, while the MEMS accelerometer at a first orientation relative to gravity, a first voltage from the power source to the test electrode, wherein the first voltage causes a first movement of the proof mass, wherein in the first orientation the proof mass is located above the sense electrode and the test electrode, and wherein the proof mass experiences a force of gravity at the first orientation;
receive, from the sense electrode, a first sense signal corresponding to the force of gravity and the first movement of the proof mass;
apply, while the MEMS accelerometer at a second orientation relative to gravity that is opposite the first orientation, a second voltage to the test electrode, wherein the second voltage causes a second movement of the proof mass, wherein in the second orientation the proof mass is located below the sense electrode and the test electrode, and wherein the proof mass experiences an equal and opposite force to the force of gravity at the second orientation of the MEMS accelerometer;
receive, from the sense electrode, a second sense signal corresponding to the equal and opposite force and the second movement of the proof mass; and
determine, based on the first voltage, the second voltage, the first sense signal, and the second sense signal, a sensitivity of the MEMS accelerometer to a first acceleration value greater than 1 G.

16. The system of claim 15, wherein the first voltage and the first sense signal are associated with the first acceleration value, and wherein applying the second voltage comprises modifying the second voltage until the second sense signal indicates that the second movement is equal to the first movement.

17. The system of claim 16, wherein the first voltage is a fixed voltage value associated with the first acceleration value, and wherein a first value of the first sense signal varies based on characteristics of the MEMS accelerometer under test.

18. The system of claim 17, wherein the second voltage is modified until a second value of the second sense signal corresponds to the first value of the first sense signal after removing effects of gravity.

19. The system of claim 18, wherein the sensitivity is determined based on the first voltage and on the modified second voltage.

20. The system of claim 16, wherein the first voltage and the second voltage are a same first voltage value, and wherein the processing circuitry is further configured to:
apply, to the test electrode while the MEMS accelerometer is at the first orientation, a third voltage to the test electrode having a second voltage value, wherein the third voltage causes a third movement of the proof mass;
receive, from the sense electrode, a third sense signal corresponding to the force of gravity and the third movement of the proof mass;
apply, to the test electrode while the MEMS accelerometer is at the second orientation, a fourth voltage to the test electrode having the second voltage value, wherein the fourth voltage causes a fourth movement of the proof mass; and
receive, from the sense electrode, a fourth sense signal corresponding to the force of gravity and the fourth movement of the proof mass, wherein the determination of the sensitivity of the MEMS accelerometer to the first acceleration value is further based on the first voltage value, the second voltage value, the third sense signal, and the fourth sense signal.
